(19) United States
(12) Patent Application Publication
(10) Pub. No.: US 2015/0051934 A1
(43) Pub. Date: Feb. 19, 2015

(54) ASYNCHRONOUS FEED OF TAGGED CONTENT BASED ON TIME CRITERIA

(71) Applicant: International Business Machines Corporation, Armonk, NY (US)

(72) Inventors: Al Chakra, Apex, NC (US); Liam Harpur, Dublin (IE); John Rice, Waterford (IE)

(73) Assignee: International Business Machines Corporation, Armonk, NY (US)

(21) Appl. No.: 13/971,296

(22) Filed: Aug. 20, 2013

Related U.S. Application Data
(63) Continuation of application No. 13/968,637, filed on Aug. 16, 2013.

(51) Int. Cl. G06Q 10/10

(52) U.S. Cl. CPC G06Q 10/1097
USPC 705/7.21

(57) ABSTRACT

In one example, an asynchronous feed of tagged content based on time criteria includes tagging content into content segments and tagging the content with a duration. The method also includes scheduling consumption of the content segments using a schedule at least one user and providing the content segments through an asynchronous feed. Additionally, a computing device for an asynchronous feed of tagged content based on time criteria is provided.

### RELATED APPLICATION

The present specification is a continuation, and claims the priority under 35 U.S.C. §120, of previous U.S. patent application Ser. No. 13/968,637, entitled “Asynchronous Feed of Tagged Content Based on Time Criteria,” filed Aug. 16, 2013, which application is incorporated herein by reference in its entirety.

### BACKGROUND

The present specification relates to the field of electronic content delivery. Specifically, it relates to automated scheduling of electronic content delivery.

People often have many different projects and goals to accomplish. In organizing themselves to complete these projects and goals, they may use a calendar to schedule their time. A common result is that a person has several larger blocks of time reserved throughout the day and smaller gaps of time that are unscheduled.

To accomplish projects and goals, people often need to gain knowledge or develop skills in the areas they are working in. Content is available in many areas to aid in gaining knowledge and developing skills. Efficiently prioritizing, delivering and scheduling this content around existing blocks of time can be challenging.

### BRIEF SUMMARY

A method is presented for implementing an asynchronous feed of tagged content based on time criteria. The method includes, tagging content into content segments, tagging the content segments with a duration, scheduling consumption of the content segments, taking into account an at least one user's availability, and providing the content to the user through an asynchronous feed.

A computing device is also presented for providing an asynchronous feed of tagged content based on time criteria. The computing device includes, a processor, a memory, an I/O interface for transferring the tagged content and user data to an external entity, the tagged content and user data being stored in the memory, a tagging module executed by the processor for tagging content into segments and for tagging the content with a duration, a scheduling module executed by the processor for scheduling the tagged content, and a feed module executed by the processor for providing the tagged content through an asynchronous feed.

Also presented is a computer program product for implementing an asynchronous feed of tagged content based on time criteria. The computer program product includes, a computer readable storage medium having computer readable program code embodied therewith, the computer readable program code configured to tag content into content segments, tag the content segments with a duration, schedule the content segments for consumption, and feed the content segments asynchronously to one or more users.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative system for an asynchronous feed of tagged content based on time criteria, according to one example of principles described herein.

FIGS. 2A-2C are a flowchart of an illustrative method for asynchronously feeding tagged content based time criteria, according to one example of principles described herein.

FIG. 3 is a flowchart of an illustrative method for preparing content based on a user's location and rescheduling consumption of content based on a user's location, mode of transportation, and meeting times, according to one example of principles described herein.

FIG. 4 is a flowchart of an illustrative method for changing a schedule based on priority, according to one example of principles described herein.

FIG. 5 is a flowchart of an illustrative method for changing a schedule to meet a deadline, according to one example of principles described herein.

FIG. 6 is a flowchart of an illustrative method for scheduling content based on a user's needs and availability, according to one example of principles described herein.

FIG. 7 is a flowchart of an illustrative method for asynchronously feeding tagged content, based time criteria, according to one example of principles described herein.

FIG. 8 is a diagram of an illustrative computing device for providing an asynchronous feed of tagged content based on time criteria, according to one example of principles described herein.

FIG. 9 is a diagram of tagged content, according to one example of principles described herein.

FIG. 10 is a diagram of a schedule, according to one example of principles described herein.

Throughout the drawings, identical reference numbers designate similar, but not necessarily identical, elements.

### DETAILED DESCRIPTION

This specification describes systems, methods, computing devices, and computer program products for scheduling the consumption of content that uses content tagged by one or more authors and data provided by one or more users to determine the schedule. Tagging includes segmenting content into more easily consumable parts and assigning a duration to each of those parts. Unscheduled time slots on a user's calendar are scheduled to provide the user a time to consume the content. Content may be provided based on how much time the user has, what content the user has already consumed, content priority, and other data provided by the author and users. If the user's schedule changes, the user's content consumption schedule may change dynamically in response. Data from users may be used to change how content is tagged and scheduled. Scheduling may be used at an individual or group level.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-atone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

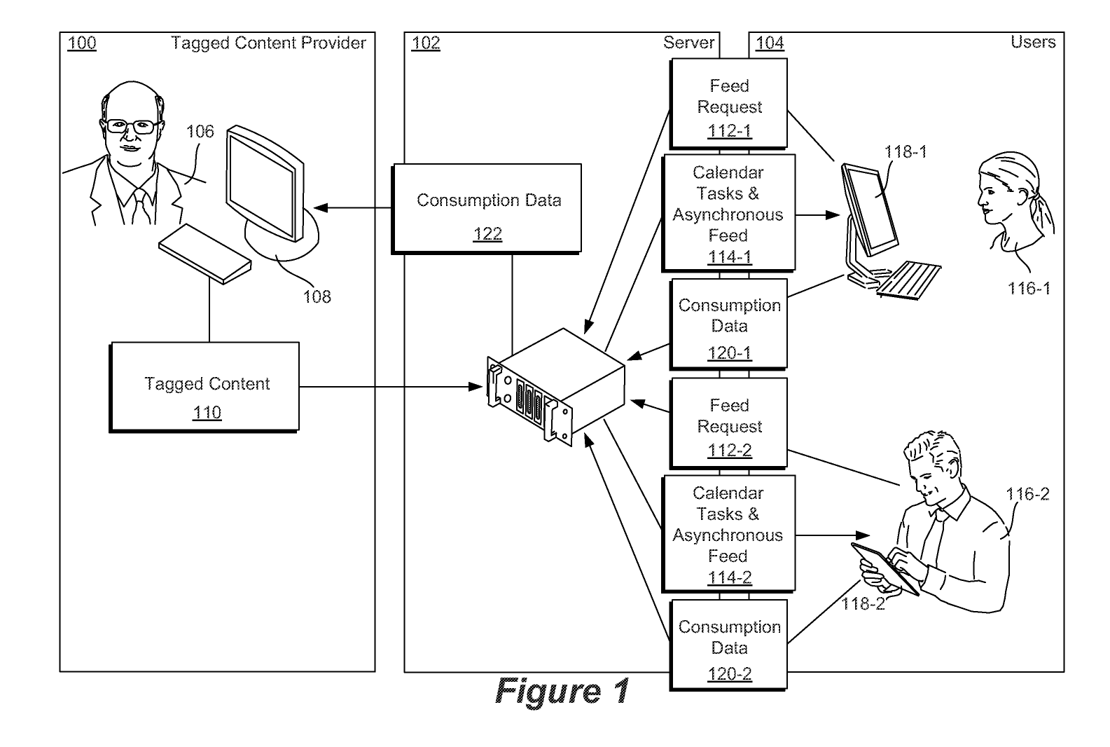

FIG. 1 is a diagram of an illustrative system for an asynchronous feed of tagged content based on time criteria. The system includes a tagged content provider (100), a server (102), and users (104).

An author (106) uses a computing device (108) to tag content (110). In this example, one author is shown, but in general, there may be any number of authors. An author may have various roles including, manager of a work group, author of an online educational course, professor of a university course, sports coach, life coach, etc.

The author (106) sends tagged content (110) to the server (102). As used in the specification and appended claims, the term “content” is used broadly. By way of example and not limitation, “content” may be a text document, PDF, video, website, audio file, slide deck, book, or link. “Content,” may also be action items, meeting invitations, steps of a process, tasks, to-do items, or assignments. As used in the specification and appended claims, the term “tag” is also used broadly. By way of example and not limitation, “tag” may be a label, metadata, markup language, or other appropriate identifier/descriptor. As used in the specification and appended claims, the term “tagged” indicates associating an attribute with a segment of content.

Each user (116-1 and 116-2) uses computing devices (118-1 and 118-2) to send a feed request (112-1 and 112-2) to the server (102). Feed requests may include requests for, but are not limited to, prerequisite content for a meeting, content for learning a skill, useful content for completing a project, or content useful for reaching a goal. In this example, there are two users shown, but any number of users may exist. Examples of computing devices may include, personal computers, smart phones, tablet computers, workstations, wearable computers, implantable computers/interfaces and other appropriate devices.

The server (102) receives the requests and creates an individualized asynchronous feed (114-1 and 114-2) for each user (116-1 and 116-2). As used in the specification and appended claims, the term “asynchronous feed” is used to describe a mechanism wherewith a user is provided content where the content is not provided all at once, but is provided on an as-needed basis.

The created asynchronous feeds and calendar tasks (114-1 and 114-2) are assigned to their respective users (116-1 and 116-2). Calendar tasks appear on the user's computing device and indicate a time slot when content is to be consumed. When the user is to consume the content, a segmented portion of the content is made or has been made available to consume during that time slot.

Consumption data (120-1 and 120-2) generated by the users' activity on the computing devices (118-1 and 118-2) is stored on the server (102). The author has access to a copy of the users' consumption data (122) from the server (102). Consumption data may include, but is not limited to, content consumption times, completion information, or reviews.

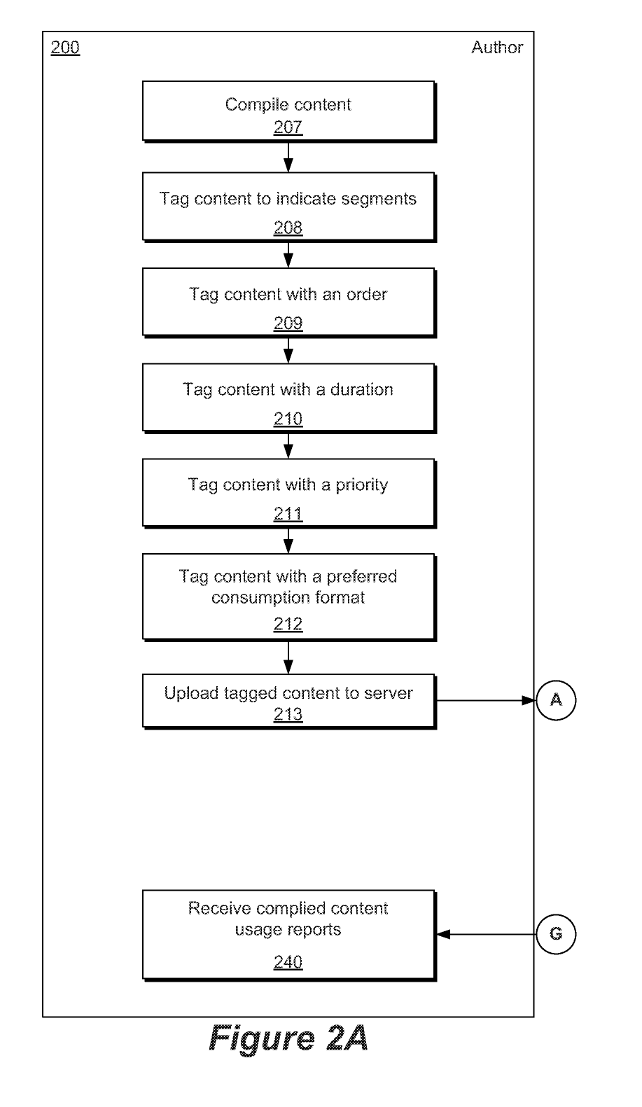

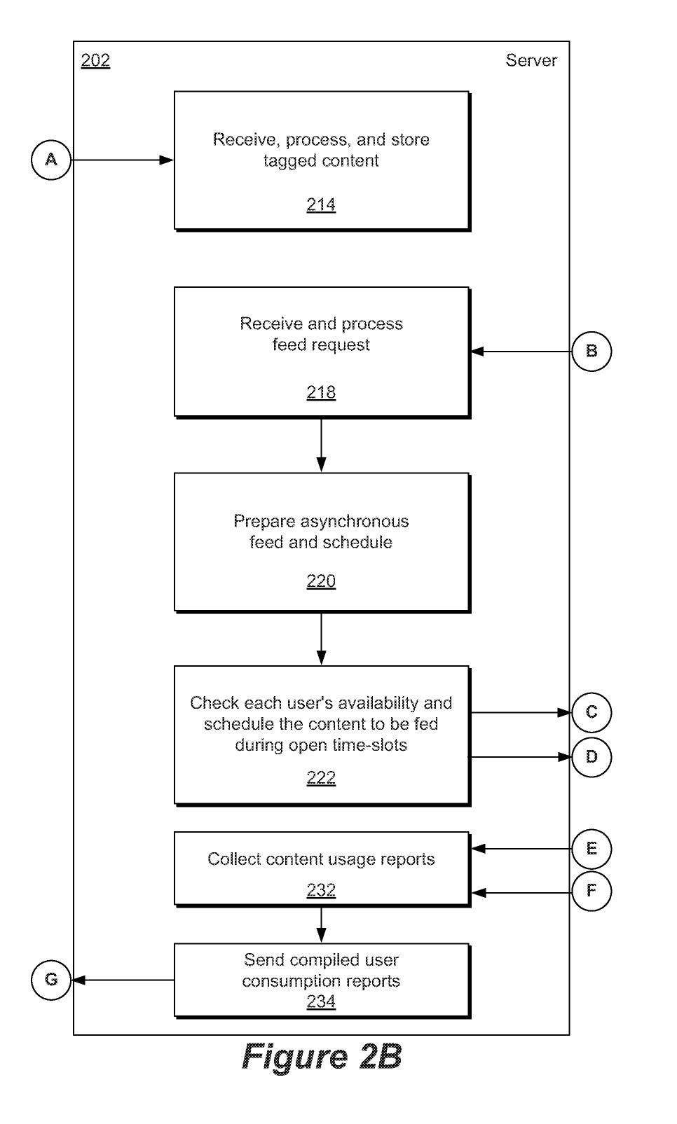

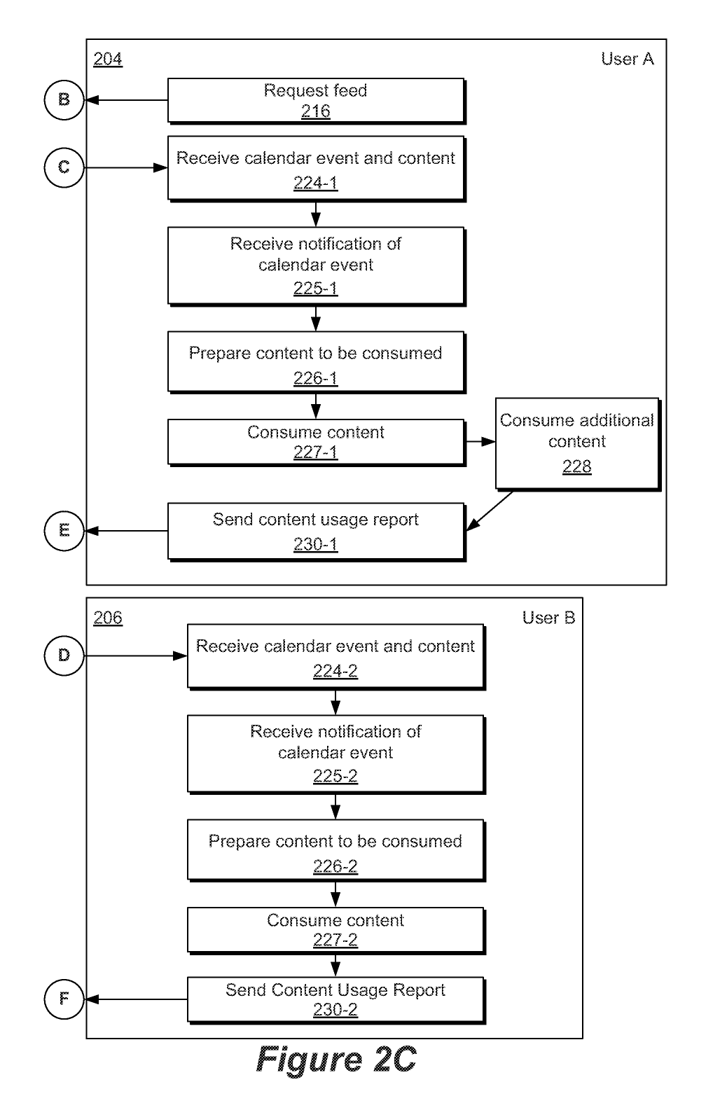

FIGS. 2A-2C show a method for implementing a system for asynchronously feeding content based on time criteria. An author (200) compiles content (207). In this example, the content is related to building a model airplane. The content includes a YouTube video that shows step-by-step instructions for assembling a model airplane and wiki page on model airplane parts and design. In addition, the content includes a list of milestones to help a user to stay on task. In this example, content includes a website, a video hosted on YouTube, and calendar tasks, but in general content may include original material written by the author or material from other sources. Content may include, but is not limited to, books, digital text documents, PDF's, videos, websites, audio files, slides, calendar tasks, meeting assignments, suggestions, instructions, etc.

The author (200) tags the content to indicate segments that may be consumed separately (208). For example, one of the articles contained in the wiki gives a basic overview of model airplane parts. There are sections on motors, airfoils, and control surfaces. The author tags each section as a separate segment and may also tag subsections of each section so that each section may be consumed within smaller, broken up, time slots. In doing so, the author also tags an order in which the content is to be completed (209). For example, the author tags the wiki section on airfoils as a prerequisite to the section on control surfaces, Additionally or alternatively, the content may be tagged automatically or semi-automatically by a computing device.

The author (200) may also tag the content with a topic. For example, the author tags the You Tube video with the topic, “Assembly”. The wiki pages are tagged with their respective topics as well.

The author (200) tags each segment of content with an estimated time for completion (210). This may be done in several ways, including but not limited to, sampling a test group, monitoring actual past consumption rates of the individual user or users as a whole. If the content is to be read, then the word count of the text or reading speed of the user may be used to estimate the time to complete the content. If the content is a video or audio file, the length of these may be used. For example, the author tags the section on airfoils with an estimated forty-five minute reading time. As discussed above, tagging content including estimating time for completion may be automatically performed without author input or may be semi-automatically performed using author input/control.

The author (200) tags the content based on priority (211). For example, the author uses a scale of priority from one to three, one being highest priority and three the lowest. The author assigns a priority of one to the first paragraphs of each section of the wiki, a priority of two to figures, tables, and pictures, and a priority of two to the rest of the text. The author may use several methods to determine how prioritize the content, including, using analytics collected from past users or test groups.

The author (200) tags the content to indicate a preferred consumption format (212). For example, the author may decide that wiki section on model airplane motors should be read, as opposed to listened to or some other form of consumption, since there are diagrams in the section which should be viewed for understanding of the project. However, the author may decide that a section on the history of model airplane building may be either read or listened to. In this case, the author tags the section as “readable” and “listenable”.

The author may tag all the content manually or may use automated methods (such as the tagging module described below) for to assist in tagging the material or the material may be tagged completely using automated methods.

The author (200) uploads the tagged content to a server (213) through path “A”. The server receives the tagged content through path “A”, does any processing needed, and stores the content (214, FIG. 2B). The server has access to content tags and may have access to certain user data. As used in the specification and appended claims, the term “user data” is used broadly. By way of example and not limitation, “user data” may be data relating to schedule and calendar, meeting times, location, activities, usage, mode of transportation and past user activity, including requests the user has made for content, content previously consumed by the user, and analytics on content use, also, contacts, messaging software, email, web browsing history, user preferences, etc. related to the user or any other user. The system may also aggregate and process similar data on a group level.

In this example there are two users, User A (204, FIG. 2C) and User B (206, FIG. 2C). The users want to build a model airplane together. User A sends a request to the server (202, FIG. 2B) through path “B” for a subscription to an asynchronous feed that will help the users to complete the project. In the request, User A indicates that User B is involved in the project as well. In this example the users specify a set date for the project to be completed; in other implementations there may not be a set due date, but the server may provide an estimated completion date based on the user's activity and content to be fed.

The server (202, FIG. 2B) receives the request through path “B” and processes it (block 218) using its database of data to prepare an asynchronous feed and schedule (block 220) for the users. For example, User A (204) and User B (206) have used the service before, so the server has information about the users' activities. This data may be collected in other ways as well, such as through a survey. The server may take into account that at least one of the users has covered some of the content before. For example, User A (204) has covered the subsection titled, “Electric Motors” from the wiki section titled, “Model Airplane Motors”. Using this information, the server is able to decide not to include this content in the feed. In this example, the server splits the reading content, i.e. the wiki pages, between the users so that no reading content is common to each individual user's feed. In other implementations, the content may be split among a group based on preferences set by the author, by the users, or the server programming.

The server (212) checks each user's availability and schedules the content to be fed during open time-slots (block 222) through paths “C” and “D”. Each user's calendar system receives its respective calendar event and content (blocks 224-1 and 224-2) through paths “C” and “D”. For example, User A (204) has an hour block of unscheduled time Monday afternoon starting at 3 pm. The server schedules that time on User A's calendar with an event for her to read the section on airfoils from the wiki, which has an estimated reading time of forty-five minutes. User B (206) has a fifteen minute time slot open after a morning meeting and just before lunch on Tuesday; so, the server schedules an event at that time for User B to read the section on the history of model airplanes from the wiki which has an estimated reading time of twelve minutes.

User A (204) and User B (206) are notified of the scheduled calendar event (blocks 225-1 and 225-2). For example, User A receives a text message from her notifying her that she is scheduled to read the section on airfoils from the wiki at 3 pm on Monday. User B receives an email notifying him that he is scheduled to read the section on the history of model airplanes from the wiki on Tuesday, fifteen minutes before lunch.

The content prepares itself to be consumed when User A (204) and User B (206) are scheduled to consume it (blocks 226-1 and 226-2). For example, User A returns to her desk from a meeting on Monday at 3 pm. She wakes up her computer from sleep mode and the content on airfoils she is to consume automatically loads in a web browser on her screen. Fifteen minutes before lunch on Tuesday, User B receives a notification on his smart phone that the section on the history of model airplanes will begin to play in one minute. A user may also access the content manually through a calendar program, notification, or other methods.

User A (204) and User B (206) consume the content (blocks 227-1 and 227-2). For example, User A reads the wiki page presented to her in her browser. User B puts headphones on and listens while the section on the history of model airplanes is played for him.

Only the content that a user is to consume is presented. However, the user may elect to view and/or consume more content than is presented. User A (204) consumes additional content (block 228). For example, User A finishes the section on airfoils in less than the estimated time. Since she has time. User A decides to read the next section of content on control surfaces as well.

The user's computing devices send a content usage report (blocks 230-1 and 230-2) to the server (202) through paths “E” and “F”. The server (202) collects the content usage reports (block 232, FIG. 2B) through paths “E” and “F”. These compiled content usage reports are then sent to the author (block 234, FIG. 2B) and the author receives them (240) through path “G”; the author may use this information to improve how the content is tagged and delivered. For example, content usage reports show that the wiki section on airfoils is often consumed much later in the process of the project than is desirable. It is determined that the time slot required is too long and the server has a hard time finding a time slot in which to schedule the content near the beginning of the project. As a result, the author may break up the section on airfoils into smaller subsections to make it easier to schedule users to consume it earlier in the project.

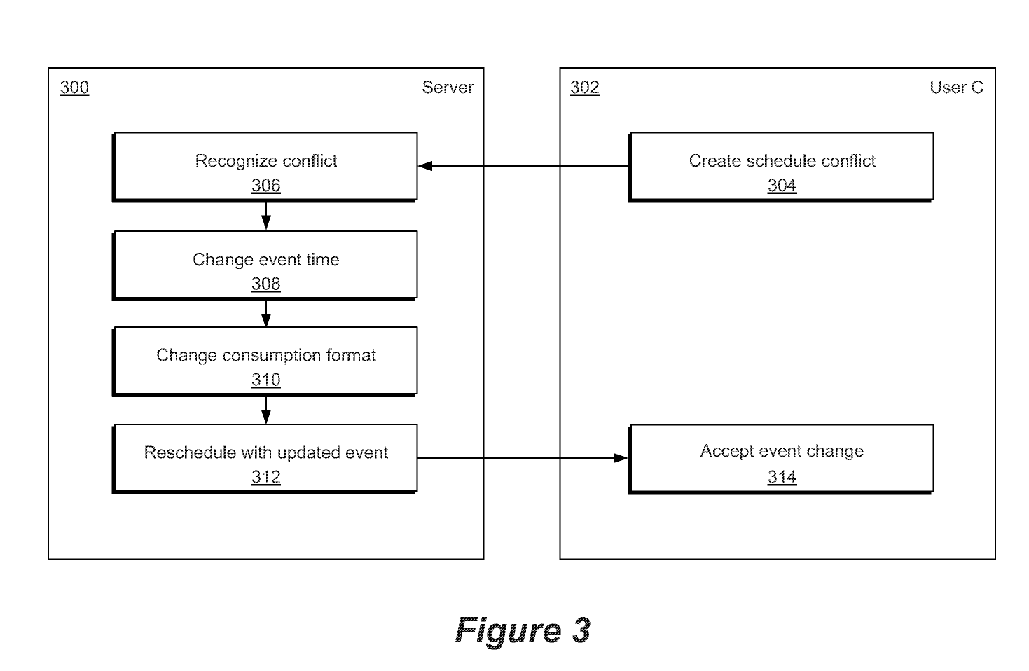

The schedule and asynchronous feed may be dynamically changed based on changes to user data such as schedules, location, and activity. FIG. 3 shows a method for preparing content based on a user's location and rescheduling consumption of content based on a user's location, mode of transportation, and schedule.

In this implementation, a server (300) has certain control of and access to a computing device of a user, User C (302). User C (302) is scheduled to read a chapter on machine learning from a PDF; the reading is expected to take ten minutes and is scheduled in User C's electronic calendar just before a calendar task reserving the lunch hour on Wednesday. User C is invited to lunch on Wednesday with a client at a location that has a fifteen-minute travel time by subway. User C makes the lunch calendar task in his calendar into a meeting and adjusts the timing to start fifteen minutes earlier. User C has created a schedule conflict (block 304).

The server (300) recognizes a conflict in User C's calendar (block 306) and changes the event time for consuming the chapter on the machine learning to start a few minutes earlier (block 308). The server recognizes that User C will be traveling to the lunch appointment by subway and in response, may also change the consumption format (block 310) to include an audio version of the PDF. The server reschedules User C's calendar with the updated event (312) and User C accepts the event change (314). In this example, the user accepted the event change, but in other examples the user may not need to make any decision at all.

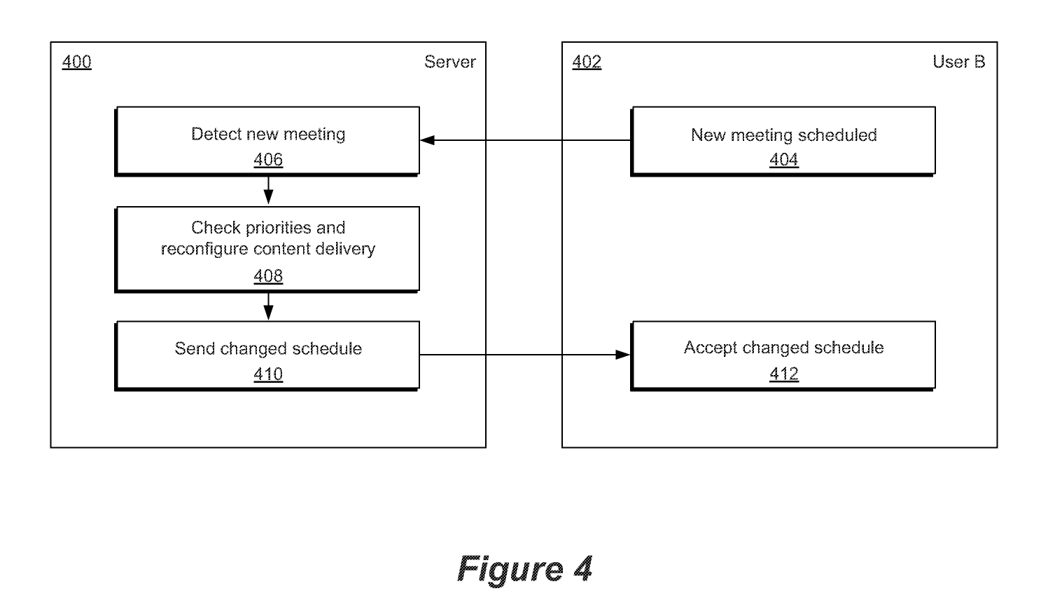

Schedules may also be changed based one or more priorities. Referring now to FIG. 4, FIG. 4 shows a method for changing schedules based on priority. In this implementation there is a server (400) for controlling the content scheduling and a user, User B (402).

In this example, User B (402), in addition to the model airplane project, is working on an autopilot programming project. Both projects have the same due date. However, a new meeting for the autopilot programming project is scheduled (block 404) for Friday. There are no meetings scheduled for the model airplane project for two weeks. The server (400) detects that the meeting has been planned (block 406). The server checks priorities and reconfigures the content delivery (block 408) so that priority goes to the autopilot programming content that needs to be covered before the Friday meeting. The server sends the changed schedule to User B's calendar and scheduling system (block 410) and User B accepts the changed schedule (block 412). In this example, the user accepted the changed schedule, but in other examples the user may not need to make any decision at all.

The schedule may also be changed based on priority in order to meet a deadline and a user does not have enough free time to consume all the required content before that deadline.

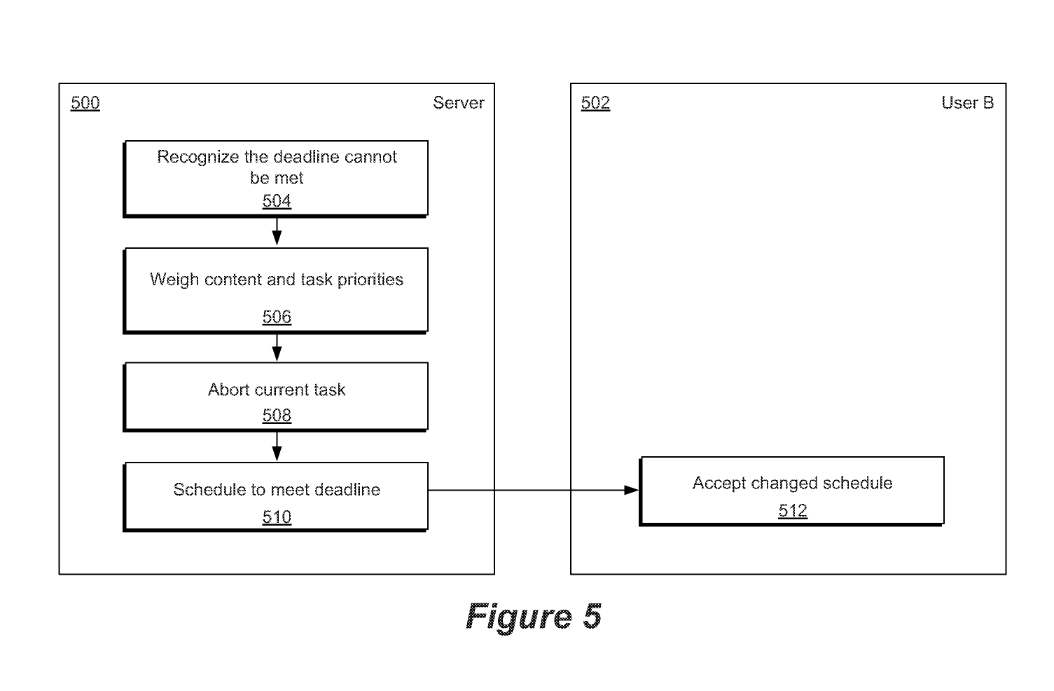

FIG. 5 shows a method for scheduling content to meet a deadline. In this implementation there is a server (500) for controlling the content scheduling and a user, User B (502).

In this example, User B (502) has not finished enough of the reading content to start building the model airplane with the aid of the instructional YouTube video. The server (500) recognizes that the deadline cannot be met (block 504) unless the group starts building the model airplane immediately. The server weighs content and task priorities (block 506) and determines that finishing the model airplane on time is more important than User B finishing the reading. As a result, the server aborts the current task (block 508) and immediately starts scheduling the highest priority content and tasks in order to meet the deadline (block 510) i.e. the YouTube video and building the model airplane. User B accepts the changed schedule (block 512).

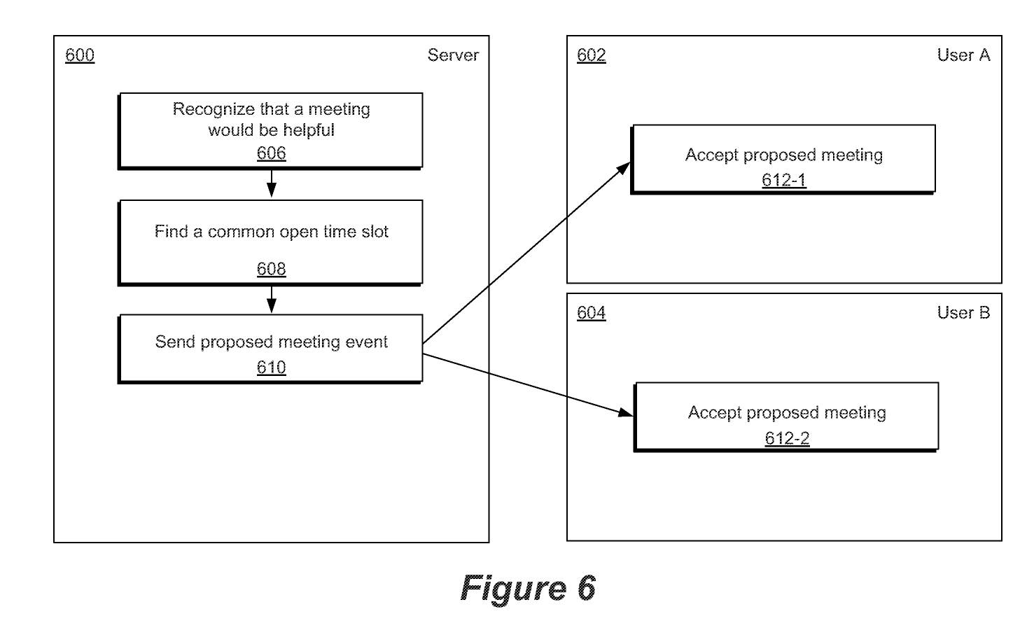

The server may schedule meetings based on user's needs and availability. FIG. 6 shows a method for scheduling content based on a user's needs and availability. In this example there is a server (600) for controlling the schedule of two users, User A (602) and User B (604).

In this example, User A (602) has completed more material than User B (604). It would be advantageous for User A to meet with User B to teach User B what he needs to know. The server (600) recognizes that a meeting would be helpful (block 606) and finds a time for User A and User B to meet when they have a common time slot open (block 608). The server then sends the proposed meeting event to the users (block 610). User A and User B accept the proposed meeting (block 612-1 and 612-2). In this example, User A and User B work in the same location; in the event that User's A and B do not work in the same location, the server may determine when User's A and B will be near the same location and suggest to the users that they meet at that time.

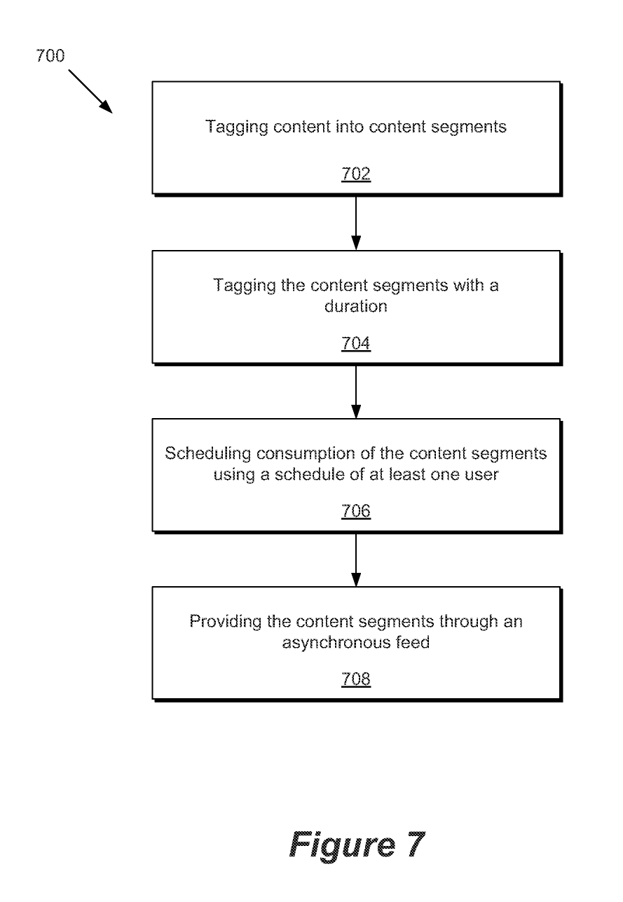

FIG. 7 shows a flowchart of a method (700) for asynchronously feeding tagged content based on time criteria. This method is similar to the method shown above but with less detail.

The method (700) includes tagging content stored in a computer-readable memory into content segments (block 702). For example, a book may be divided into chapters, a reference website may be divided into sections or pages, a video may be divided into parts, and a goal may be divided up into a list of single actions.

The method (700) also includes tagging the content segments with a duration (block 704). For example, a chapter of a book may be tagged with an estimated reading time and a video may be tagged with a viewing time. The various tags are stored in the computer readable memory with the content segments.

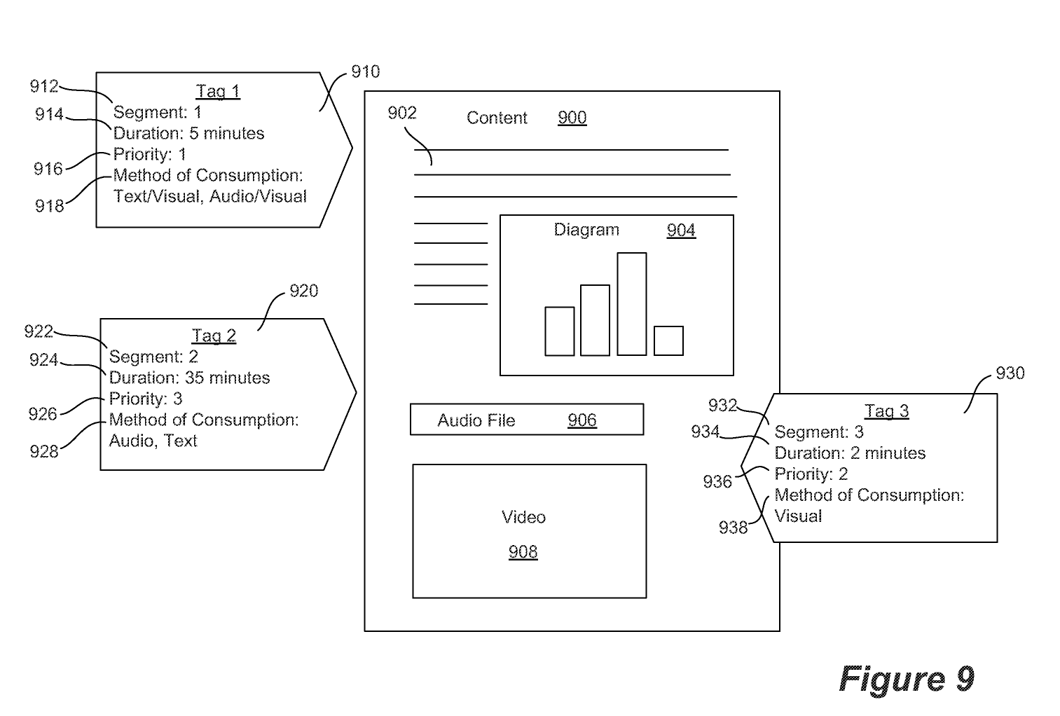

In the method of FIG. 7 the content is tagged into content segments and tagged with a duration, but the content may be tagged with a variety of different identifiers/descriptors. FIG. 9 shows an example of tagged content. The content (900) includes text (902), a diagram (904), an audio file (906), and a video (908).

Tag 1 (910) is a group of tags associated with the text (902) and diagram (904) content. Tag 1 (910) is tagged as segment 1 (912) so that the text and diagram content are consumed chronologically before other content. Additionally, Tag 1 has an expected duration of five minutes (914), that is, the user is expected to take five minutes to read the text and view the diagram. Tag 1 has a priority of “1” (916); in this example “1” is the highest priority so, in the event that not all the content can be consumed in the time allotted, the text and diagram will be scheduled for consumption before any tags with a higher numbered priority. Tag 1 also includes two methods of consumption (918), which are text/visual and audio/visual; the text and diagram may be consumed by visually reading the text and viewing the diagram or the text may be listened to but the diagram still must be viewed.

Tag 2 (920) is a group of tags associated with the audio file (906). The audio file has a segment number of 2 (922), a duration of 35 minutes (924), a priority of 3 (926) and methods of consumption (928) include audio and text.

Tag 3 (930) is a group of tags associated with the video (908). The video has a segment number of 3 (932), a duration of 2 minutes (934), a priority of 2 (936), and a method of consumption of visual (938).

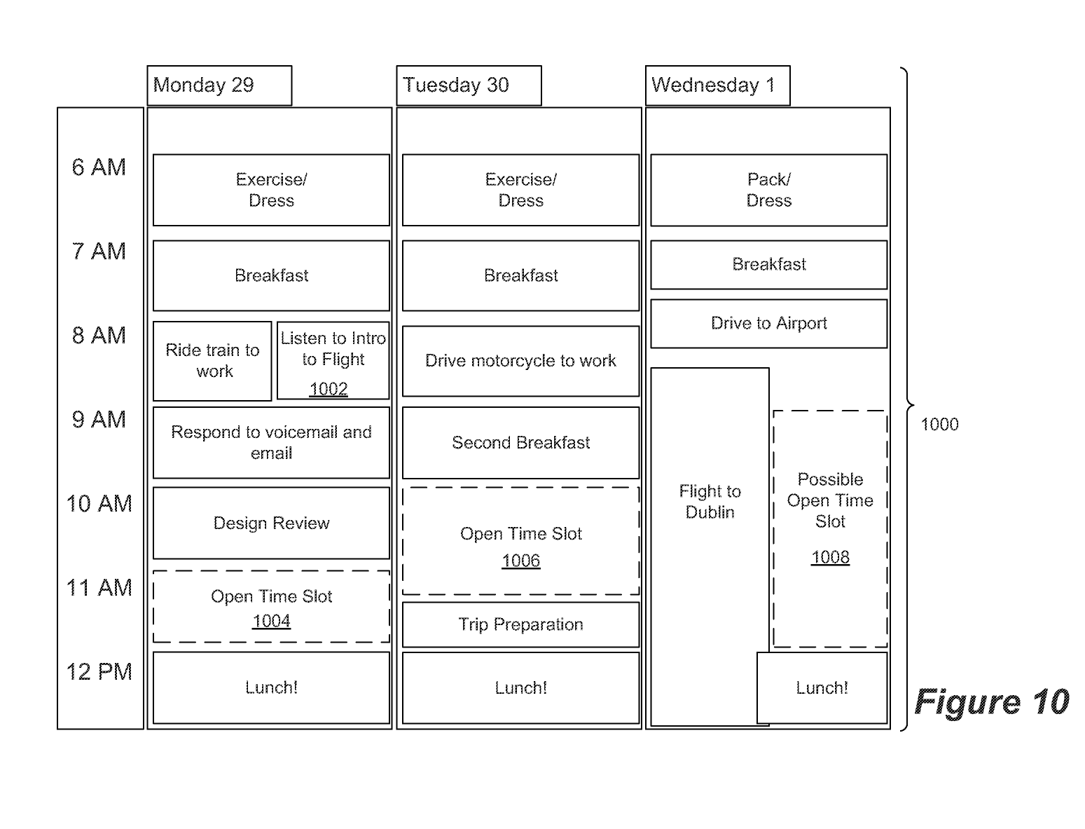

Returning now to the method described in FIG. 7, the method (700) also includes scheduling, by a computational processor, consumption of the content segments using the schedule of at least one user (block 706). Content segments may be scheduled into time slots of corresponding lengths of time. FIG. 10 shows an example of a user schedule. The schedule is shown in an electronic calendar (1000) where the user has scheduled their time with various calendar events. There are number of blocks of scheduled user activity, some of which may be compatible with consumption of one or more content segments. A little after 8 am on Monday the user has been scheduled to listen to content titled, “Intro to Flight” while riding the train to work. There are open time slots at 11 am on Monday (1004) and 10 am on Tuesday (1006). The user need not specify an open time slot explicitly, but in some implementations the user may choose to do so.

Open time slots are automatically scheduled by the computational processor with appropriate matching content. For example, if the user needs to watch a video that is a little longer than an hour, then the video could be scheduled in the open time slot on Tuesday (1006), since it wouldn't fit in the time slot on Monday (1004). Some time slots may be scheduled if the method of consumption and user preferences match content that is to be scheduled. For example, there is a possible open time slot on Wednesday starting at 9 am (1008) during the user's flight. The user's preferences allow content to be scheduled during a flight as long as the method of consumption is audio. If there is pending audio content to be scheduled, part of the flight time will be scheduled to consume it.

Returning now to the method described in FIG. 7, the method (700) also includes providing, by the computational processor, the content segments through an asynchronous feed (block 708). The content is not fed all at once, only the content that can be consumed by the user in the open time slots they have is fed.

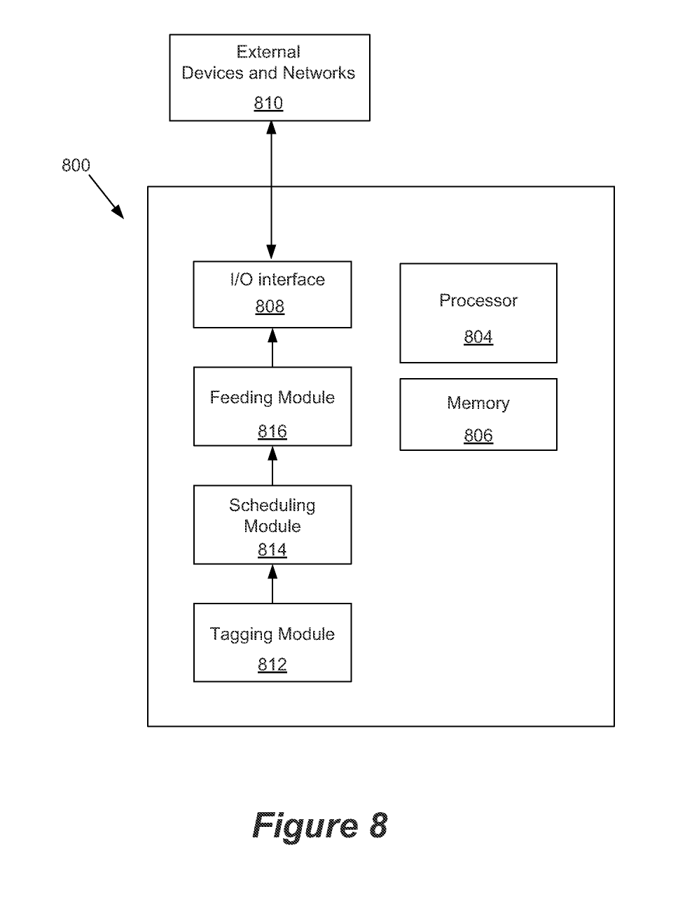

FIG. 8 is a diagram of a computing device (800) for providing an asynchronous feed of tagged content based on time criteria. The computing device (800) includes a processor (804) and a memory (806). The processor retrieves instructions from the memory and executes those instructions to control and/or implement the various functionalities and modules of the computing device. For example, the computing device and instructions may execute any of the methods described above.

The computing device also includes an input/output component which is illustrated as an I/O interface (808). The I/O interface may interact with a variety of elements, including external devices and networks (810). These interactions may include accepting inputs, such as receiving and sending user data, tagged content, and sending notifications to the user of scheduled content.

The tagging module (812) takes content stored in the memory (806) and adds tags to the content. Tags are used to segment content and to give the content an estimated duration. Tags may also be used for a variety of other reasons such as tagging each content segment with a priority and at least one method of consumption. In some examples, the tagging module may use data about the user's consumption to determine how the content is tagged. For example, if the user is an unusually fast reader, the tagging module may tag content segments containing reading content with a shorter consumption duration or may make the reading segments larger.

The scheduling module (814) uses user data and content segments tagged with a duration to find and schedule open time-slots in a user's calendar to schedule the tagged content. In general, the scheduling module schedules higher priority content to be consumed first and matches a duration of each content segment with an open time period or compatible scheduled activity that has a duration longer that the duration of the content segment.

The scheduling module also matches a consumption method of each content segment scheduled during a compatible scheduled activity so that the user can consume the content segment while performing the compatible scheduled activity. For example, a scheduled activity may be traveling. Various methods can be used to determine the mode of travel and the appropriate format of the content segments that will be compatible. For example, any type of content could be consumed while traveling on an airplane or train, but only audio content is compatible with driving a car.

A variety of additional factors may be considered. For example, the scheduling module may use a location of the user to schedule content segments. When the user is at work, only content segments related to work are presented to the user. When the user is at home, recreational or hobby content may be scheduled. The scheduling module may also reschedule consumption of the content segments based on changes to the user data. For example, if the user's schedule changes, the content segments can be rescheduled. Additionally, the user data may reflect changes in the location and mode of transportation of the user. For example, the scheduling module may determine that a user who was scheduled to take a train is instead driving. The scheduling module can then update content segments that are being fed to the user to eliminate video content.

The feeding module (816) uses the schedule to feed content asynchronously to external devices and networks (810) through the I/O interface (808). The feeding module determines that a content segment is scheduled to be consumed and pushes the content segment to the user prior to the scheduled consumption and notifies the user that the content is available for consumption.

Although the functionality of the computing device for providing an asynchronous feed of tagged content based on time criteria is illustrated within a single computing device, the functionality can be distributed over multiple computing devices, networks and systems. Further, the division and description of the various modules in the computing device are only examples. The functionality could be described in a number of alternative ways. For example, the functionality of the various modules could be combined, split, or reordered. Further, there may be a number of functions of the computing device that are not shown in FIG. 8 but are nonetheless present.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise, it will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for implementing an asynchronous feed of tagged content based on time criteria comprises:
tagging content stored in a computer-readable memory into content segments;
tagging said content segments with a duration and storing tags with said content in said computer-readable memory;
scheduling, by a computational processor, consumption of said content segments using a schedule of an at least one user; and
providing, by said computational processor, said content segments from said computer-readable memory to said at least one user through an asynchronous feed.

2. The method of claim 1, further comprising tagging said content segments with at least one order.

3. The method of claim 1, further comprising tagging said content segments with at least one priority.

4. The method of claim 1, further comprising tagging said content segments with at least one method of consumption.

5. The method of claim 1, further comprising notifying said user of scheduled content.

6. The method of claim 1, further comprising preparing said content segments to be compatible with a scheduled activity of said at least one user such that said at least one user can consume said prepared content segments while performing said scheduled activity.

7. The method of claim 6, further comprising using a location of said at least one user to select an at least one consumption format for said content segments.

8. The method of claim 1, further comprising rescheduling consumption of said content segments based on changes to user data of said at least one user.

9. The method of claim 8, wherein said user data comprises an at least one location.

10. The method of claim 8, wherein said user data comprises an at least one mode of transportation.

11. The method of claim 8, wherein said user data comprises an at least one meeting time.

12. The method of claim 8, wherein said user data comprises an at least one priority.

13. The method of claim 1, further comprising using data describing user consumption to determine how said content is tagged.

14. The method of claim 1, further comprising coordinating said scheduling said content for a group of users.

15. The method of claim 14, further comprising dividing content among said group of users.

16. The method of claim 1,
wherein tagging said content comprises assigning a priority to each content segment, assigning a duration to each content segment, and assigning at least one method of consumption to each content segment; and
wherein scheduling consumption of said content segments comprises analyzing an electronic calendar of said at least one user and matching content segments to open time periods and compatible scheduled activities.

17. The method of claim 16, wherein matching content segments to open time periods and compatible scheduled activities comprises:
scheduling higher priority content to be consumed first;
matching a duration of each content segment scheduled with an open time period or compatible scheduled activity that has a duration longer than said duration of said content segment; and
matching a consumption method of each content segment scheduled during a compatible scheduled activity so that said at least one user can consume said content segment while performing said scheduled activity.

18. A method comprises:
tagging content stored in a computer-readable memory to separate the content into content segments;
tagging said content segments by assigning a priority to each content segment, assigning a duration to each content segment, and assigning at least one method of consumption to each content segment;
storing tags with said content in said computer-readable memory;
scheduling, by a computational processor, consumption of said content segments using a schedule of an at least one user by:
analyzing an electronic calendar of a user; and
matching prioritized content segments to open time periods and compatible scheduled activities;
using a scheduled activity of said at least one user during a time period scheduled for consumption of a scheduled content segment to select a consumption format for said scheduled content segment;
notifying said user of said scheduled content segment; and
providing, by said computational processor, said scheduled content segment from said computer-readable memory to said at least one user in said consumption format through an asynchronous feed.

19. The method of claim 18, further comprising preparing said content segments to be compatible with a scheduled activity of said at least one user such that said at least one user can consume said prepared content segments while performing said scheduled activity, wherein said scheduled activity comprises traveling on a mode of transportation.

20. The method of claim 18, wherein matching content segments to open time periods and compatible scheduled activities comprises:
scheduling higher priority content to be consumed first;
matching a duration of each content segment with an open time period or compatible scheduled activity that has a duration longer than said duration of said content segment; and
matching a consumption method of each content segment scheduled during a compatible scheduled activity so that said at least one user can consume content while performing said compatible scheduled activity.
